(19) United States
(12) Patent Application Publication
(10) Pub. No.: US 2008/0180848 A1
(43) Pub. Date: Jul. 31, 2008

(54) Controlling bond pad migration in a direct access storage device

(76) Inventors: Manoj Chopra, Union City, CA (US); Eric W. Flint, San Jose, CA (US); Jeffrey P. Gunder, Los Altos, CA (US); Victor H. Perez, Mexico (MX); Doug Williams, San Jose, CA (US)

Correspondence Address: HITACHI C/O WAGNER BLECHER LLP, 123 WESTRIDGE DRIVE, WATSONVILLE, CA, 95076, US

(21) Appl. No.: 11/701,038

(22) Filed: Jan. 31, 2007

(51) Int. Cl. G11B 15/64

(52) U.S. Cl. 360/237

(57) ABSTRACT

A slider assembly used in a direct access storage device includes electrically conductive bond pads formed on the slider body. A rigid and electrically non-conductive material surrounds and abuts the bond pads. The material and the bond pads form a planar surface. The material prevents the bond pads from migrating and shorting, so that the bond pads can be placed closer together.

### TECHNICAL FIELD

This invention relates generally to the field of direct access storage devices.

### BACKGROUND

Direct access storage devices (DASDs) have become part of everyday life, and as such, the capability to manipulate and store larger amounts of data at greater speeds is expected. To meet these expectations, DASDs such as hard disk drives (HDDs) have undergone many changes.

The basic hard disk drive model resembles a phonograph. That is, the hard disk drive model includes a storage disk, or hard disk, that spins at a standard rotational speed. An actuator arm with a suspended slider is utilized to reach out over the disk. The arm carries a head assembly that has a magnetic read/write transducer, or head, for writing or reading information to or from a location on the disk. The complete head assembly, e.g., the suspension and head, is called a head gimbal assembly (HGA).

Bond pads are formed on a surface of the slider. A conductive path extends from the head to the bond pads, which in turn are connected to wires that carry information between the disk and the host computer system.

Advances in magnetic read/write heads as well as in the disk have allowed more data to be stored and quickly accessed. The ability of an HDD to access this data is largely a function of the performance of the mechanical components of the HDD. Once this data is accessed, the ability of an HDD to read and write this data is primarily a function of the electrical components of the HDD. Other advances have led to significant reductions in the size of the hard disk drive.

A problem that can occur during fabrication is referred to as “bond pad bridging.” After the bond pads are formed, subsequent cleaning and mechanical processes during fabrication may cause the pads to spread, bringing adjacent pads in contact with each other, thereby introducing a short. If the bond pads are placed closer to each—to increase the number of bond pads without increasing the size of the device, for example—the problem of bond pad bridging can become worse.

If a short is introduced, the device has to be discarded, reducing yields. A solution to the problem of bond pad bridging would therefore provide value by increasing yields.

### SUMMARY

A slider assembly used in a direct access storage device includes electrically conductive bond pads formed on and protruding from the slider body. A rigid and electrically non-conductive material surrounds and abuts the bond pads. The material and the bond pads form a planar surface. The material prevents the bond pads from migrating and shorting, so that the bond pads can be placed closer together.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 illustrates an exploded view of a hard disk drive including an enlarged representation of a slider assembly according to embodiments of the present invention.

FIG. 2 is a flowchart of a process for forming a slider assembly according to embodiments of the present invention.

FIG. 3 illustrates various stages in a process for forming a slider assembly according to embodiments of the present invention.

### DETAILED DESCRIPTION

Reference will now be made in detail to embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

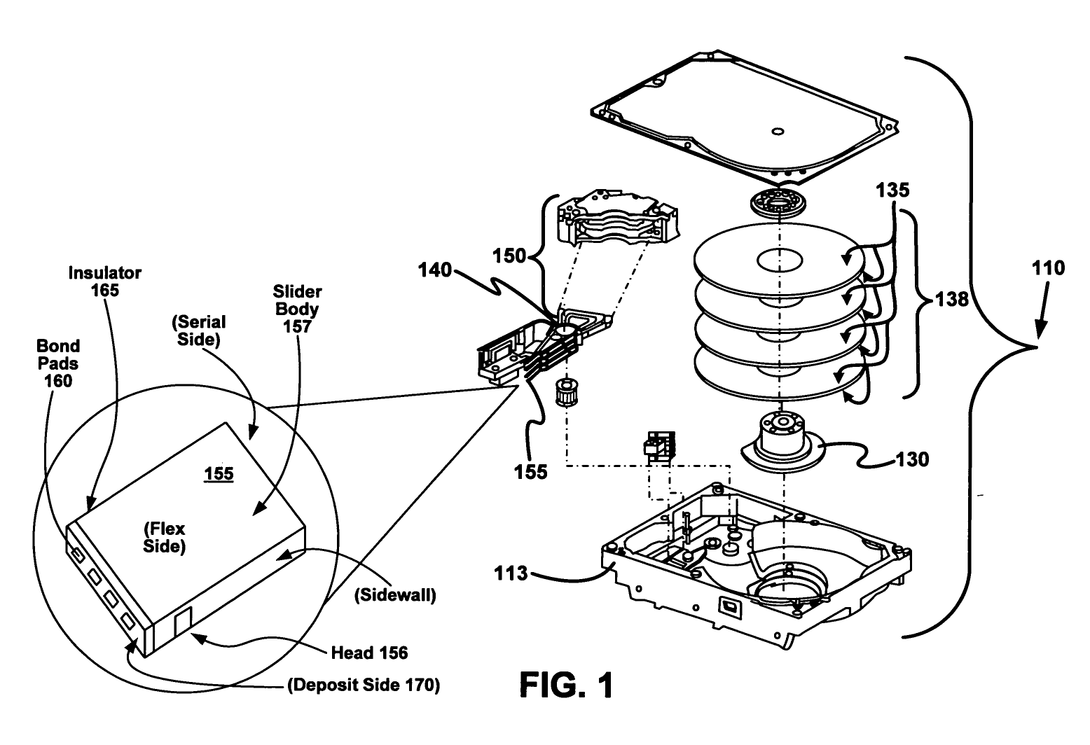

FIG. 1 illustrates an exploded view of an example of a hard disk drive (HDD) 110 including an enlarged representation of a slider assembly 155 upon which embodiments of the present invention can be implemented. HDD 110 represents one example of the many types of direct access storage devices (DASDs) and HDDs in which embodiments in accordance with the present invention can be implemented.

In the example of FIG. 1, the components of HDD 110 are assembled into base casting 113, which provides attachment and registration points for components and sub-assemblies. A disk's surface is spun at high speed by means of a motor hub assembly 130. Data is recorded onto the surface of a disk 135 in a pattern of concentric rings known as data tracks. Data tracks are recorded onto the surface of a disk 135 by means of a magnetic head 156, which can be included in the body of the slider assembly 155 and which can also be used to read data from the data tracks. When the disk is spun by the motor hub assembly 130, the slider assembly 155 is supported on a thin cushion of air between the disk and an air bearing surface (not shown). An actuator 140 can be used to position the magnetic head 156 over the disk 135. In general, the motor-hub assembly 130 supports the disk stack 138 so that the surface of a disk 135 can be spun adjacent to the slider assembly 155, thus allowing the magnetic head 156 to read and write data tracks on the surface of the disk 135. HDD 110 can include other components in addition to those shown or discussed.

Slider assembly 155, shown in enlarged view, is in general composed of a substrate upon which various materials and devices are added; not all of these materials and devices are shown or discussed. Those material and devices generally constitute a slider body 157. The slider body 157 has surfaces that can be referred to as the serial side (on which a serial number may appear), the sidewalls, and the flex side. The slider body 157 also has a surface that can be referred to as the deposit side 170, on which a number of bond pads 160 are formed. In the example of FIG. 1, four (4) bond pads 160 are shown; however, the present invention is not so limited. Some HDDs may incorporate up to nine (9) bond pads, but again the present invention is not so limited. In general, the bond pads 160 are made of a conductive metal. In one embodiment, the bond pads 160 are made of gold.

The magnetic head 156 is formed within or on slider body 157. Although not shown in FIG. 1, a conductive path exists between the head 156 and the bond pads 160. The bond pads 160 in turn can be connected (bonded) to data transmission lines (e.g., leads or wires), thereby providing a path between the surface of a disk 135 and a host computer system (not shown) in which the HDD 110 resides, so that information can be passed back and forth between the disk and the host computer system.

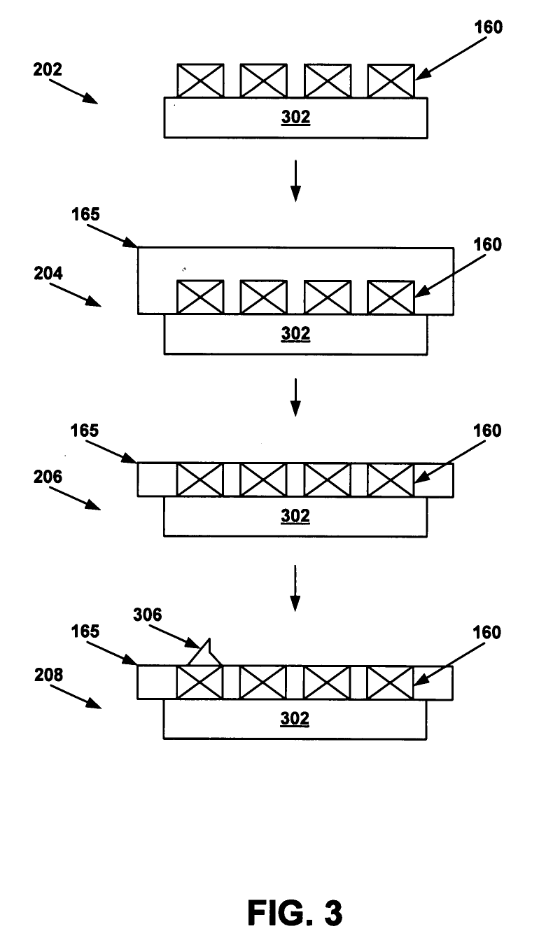

According to embodiments of the present invention, the bond pads 160 are surrounded by and abut an insulator 165. Furthermore, the exposed surfaces of the bond pads 160 and the insulator 165 are flush with each other, so that they form a planar surface on deposit side 170 (refer also to FIG. 3, discussed below).

In one embodiment, insulator 165 of FIG. 1 is made of the same material as the substrate of slider body 157. In one embodiment, insulator 165 is made of aluminum, titanium and carbide, sometimes referred to as AlTiC. In another embodiment, insulator 165 is made of alumina (Al₂O₃). In yet another embodiment, insulator 165 is a ceramic material.

In addition to being non-conductive, insulator 165 is a rigid material that is harder than the material from which the bond pads 160 are made. By virtue of its hardness and rigidity, insulator 165 prevents the bond pads 160 from spreading or migrating. In effect, insulator 165 separately encloses each of the bond pads 160, so that spreading of the bond pads is inhibited during subsequent cleaning and mechanical processes during fabrication. If the bond pads do not spread, then they cannot come in contact with each other. Consequently, instances of bond pad bridging can be reduced or prevented, thereby diminishing or eliminating a potential source of shorts and increasing yields. Indeed, available data shows that, with the introduction of the present invention, instances of bond pad bridging are reduced from about 1.65 percent to about 0.14 percent.

Also, because bond pad bridging can be reduced if not prevented, the bond pads 160 can be placed closer to each other, allowing the slider assembly 155 to be reduced in size, or allowing the use of more bond pads without having to increase the size of the slider assembly. In one embodiment, the distance between bond pads is less than 4-5 microns, and distances less than that are achievable. More bond pads are advantageous, permitting additional electrical connections that can be used for reading and writing information or for connecting with other features associated with the head 156, such as fly height sensors.

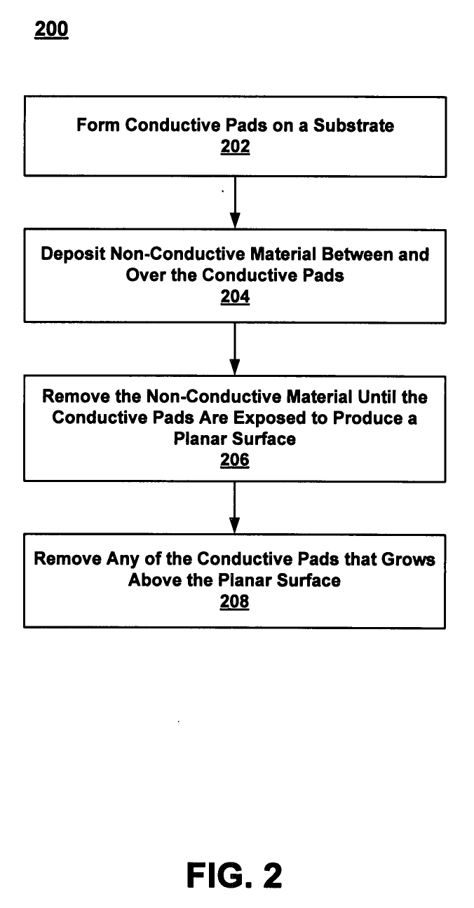

FIG. 2 is a flowchart 200 of a process for forming a slider assembly (e.g., slider assembly 155 of FIG. 1) according to embodiments of the present invention. FIG. 3 illustrates certain stages in the process of FIG. 2.

Although specific steps are disclosed in flowchart 200, such steps are exemplary. That is, the present invention is well-suited to various other steps or variations of the steps recited in flowchart 200.

Also, other processes and steps associated with the fabrication of a slider assembly, HDD or DASD may be performed along with the process illustrated by FIGS. 2 and 3; that is, there may be a number of process steps before and after the steps shown and described by FIGS. 2 and 3. Importantly, embodiments of the present invention can be implemented in conjunction with these other (conventional) processes and steps without significantly perturbing them. Generally speaking, process steps associated with the various embodiments of the present invention can be added to a conventional process without significantly affecting the peripheral processes and steps.

With reference to FIGS. 2 and 3, in block 202, conductive bond pads 160 are formed on a substrate 302. In one embodiment, the bond pads 160 are made of gold. The bond pads protrude from the surface to a specified height. In one embodiment, the height of the bond pads is about 4-6 microns. In various embodiments, the substrate 302 is made of AlTiC or alumina.

In block 204, a non-conductive material (insulator 165) is deposited or grown between and over the bond pads 160 so that the bond pads are covered by the insulator. In one embodiment, the insulator 165 is deposited to a depth of about six (6) microns. In one embodiment, the insulator 165 is made of the same material as the substrate 302.

In block 206, a process such as, but not limited to, chemical-mechanical polishing (CMP) is employed to remove the insulator 165 until the bond pads 160 just barely begin to show, exposing enough of the bond pads 160 to permit wire bonding. As a result, the specified height of the bond pads is maintained, and the bond pads 160 and the insulator 165 form a planar surface. That is, the surface of deposit side 170 (FIG. 1) is planar. In a sense, at this point in the fabrication process, the bond pads 160 act as a reference surface—the specified height of the bond pads serves as a reference point that identifies how much of the insulator 165 to remove and when to stop removing the insulator material.

Continuing with reference to FIGS. 2 and 3, the bond pads are bonded to a wire or lead. The wire bonding process may cause a portion 306 of a bond pad to grow outward, so that the surface of the bond pad is no longer flush with the surface of the insulator 165.

In block 208, a process such as CMP can be used to remove the portion 306, so that the surfaces of the bond pad and the insulator are again flush. Because the insulator 165 is made of a material that is harder than the material used to make the bond pads, the surface of the insulator serves as a reference surface at this point in the fabrication process—the depth of the insulator 165 serves as a reference point that identifies how much of the bond pads to remove and when to stop removing the bond pad material, so that the stripe height can be properly controlled.

In summary, embodiments in accordance with the present invention pertain to HDD and DASD sliders, and methods for fabricating such devices, in which the potential for bond pad bridging is reduced or eliminated, thereby increasing yields.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A slider assembly used in a direct access storage device, said slider comprising:
a slider body comprising a substrate and a magnetic head;
a plurality of electrically conductive bond pads formed on said slider body and extending from said slider body by a specified dimension, said bond pads operable for electrically coupling said magnetic head to a plurality of data transmission lines; and
a rigid and electrically non-conductive material that surrounds and abuts said bond pads, said non-conductive material grown between and over said bond pads and then partially removed until said bond pads are exposed, wherein said specified dimension of said bond pads is maintained and said material and said bond pads form a planar surface.

2. The slider assembly of claim 1 wherein said substrate and said non-conductive material consist of the same material.

3. The slider assembly of claim 2 wherein said same material is selected from the group consisting of: alumina and AlTiC.

4. The slider assembly of claim 1 wherein said non-conductive material is a ceramic.

5. The slider assembly of claim 1 wherein said bond pads consist of gold.

6. The slider assembly of claim 1 wherein said bond pads protrude from said slider body a distance in a range of four to six microns.

7. The slider assembly of claim 1 wherein a distance between adjacent bond pads is less than approximately four microns.

8. A method of forming a slider assembly used in a direct access storage device, said method comprising:
forming a plurality of electrically conductive bond pads on a substrate, said bond pads formed to a specified height, said bond pads operable for electrically coupling a magnetic head in said substrate to a plurality of data transmission lines;
growing a rigid and non-conductive material between and over said bond pads such that said non-conductive material surrounds and abuts said bond pads;
removing said non-conductive material until said bond pads are exposed without reducing said specified height of said bond pads and such that said a planar surface comprising exposed bond pads and remaining non-conductive material is formed.

9. The method of claim 8 wherein said substrate and said non-conductive material consist of the same material.

10. The method of claim 9 wherein said same material is selected from the group consisting of: alumina and AlTiC.

11. The method of claim 8 wherein said non-conductive material is a ceramic.

12. The method of claim 8 wherein said bond pads consist of gold.

13. The method of claim 8 wherein said bond pads protrude from said slider body a distance in a range of four to six microns.

14. The method of claim 8 wherein a distance between adjacent bond pads is less than approximately four microns.

15. The method of claim 8 further comprising:
bonding said bond pads to said data transmission lines; and
planing any portion of said bond pads that has grown above said planar surface as a result of said bonding, wherein said non-conductive material provides a reference surface such that said specified height of said bond pads is not reduced by said planing.

16. A mechanism for preventing gold pad bridging, said mechanism comprising:
means for reading and writing data from and to a magnetic storage means;
means for coupling said means for reading and writing to a host computer, said means for coupling comprising a first gold pad and a second gold pad separated from each other by a gap; and
means for preventing said first and second gold pads from spreading and bridging said gap, said means for preventing comprising a rigid and electrically non-conductive material that surrounds and abuts said first and second gold pads, said material and said first and second pads forming a planar surface.

17. The mechanism of claim 16 wherein said means for reading and writing data is embedded in a substrate, wherein said substrate and said non-conductive material consist of the same material.

18. The mechanism of claim 17 wherein said same material is selected from the group consisting of: alumina and AlTiC.

19. The mechanism of claim 16 wherein said non-conductive material is a ceramic.

20. The mechanism of claim 16 wherein said first and second bond pads have a height of between four and six microns.

21. The mechanism of claim 16 wherein said gap is less than approximately four microns.
